(19) United States
(12) Patent Application Publication
(10) Pub. No.: US 2024/0128487 A1
(43) Pub. Date: Apr. 18, 2024

(54) BATTERY

(71) Applicant: Zhuhai CosMX Battery Co., Ltd., Zhuhai (CN)

(72) Inventors: Xilong LI, Zhuhai (CN); Zhida WEI, Zhuhai (CN); Ning PENG, Zhuhai (CN)

(21) Appl. No.: 18/531,394

(22) Filed: Dec. 6, 2023

Related U.S. Application Data
(63) Continuation of application No. PCT/CN2022/130962, filed on Nov. 9, 2022.

(30) Foreign Application Priority Data
Dec. 14, 2021 (CN) 202123142307X

(51) Int. Cl. H01M 10/04; H01M 10/0525; H01M 50/103; H01M 50/15; H01M 50/169

(52) U.S. Cl. CPC H01M 10/04; H01M 50/103; H01M 50/15; H01M 50/169; H01M 10/0525

(57) ABSTRACT

The present application provides a battery. The battery includes a battery cell and a shell. The shell includes a first cover body, a second cover body, and an annular middle frame. The annular middle frame is arranged between the first cover body and the second cover body. The first cover body, the annular middle frame, and the second cover body are sequentially connected to form a closed cavity. The battery cell is arranged in the closed cavity. The battery of the present application can solve a problem that product yield of the shell is affected due to deformation, stacking or cracking of a plate under force in a stamping process.

### CROSS-REFERENCE TO RELATED APPLICATIONS

This application is a continuation of International Application No. PCT/CN2022/130962, filed on Nov. 9, 2022, which claims priority to Chinese patent Application No. 202123142307.X, filed on Dec. 14, 2021, entitled “BATTERY.” Both of the aforementioned applications are hereby incorporated by reference in their entireties.

### TECHNICAL FIELD

The present disclosure relates to the technical field of batteries and in particular to a battery.

### BACKGROUND

In recent years, China's continuous attention to environmental issues has led to the introduction of a series of environmentally friendly products. Batteries can be charged and discharged, and are often used as power sources to replace traditional fossil fuels to solve the environmental pollution problems caused by fossil fuels. Batteries have a high demand in the market due to their advantages such as long cycle life and high energy density. At the same time, the market size is growing rapidly.

The battery includes a battery cell and a shell for covering the battery cell. The shell is formed by an outer shell and an end cover component that are sealingly connected. The outer shell in metal material has a high popularity rate in automotive power batteries, and is usually manufactured by integrally molding using a stamping process. The stamping process is a production technology that utilizes a mold installed on a press to apply a deformation force to a plate material placed in the mold, which causes the plate material to deform in the mold, thereby obtaining a product part with a certain shape, size, and performance.

However, the outer shell usually has a depth. When using stamping technology to process the outer shell with a large depth, the plates are prone to deforming, stacking, or cracking during the stamping process, which affects the product yield of the shell.

### SUMMARY

The present application provides a battery that can solve the problem that a product yield is affected due to deforming, stacking, or cracking caused by stress of a plate material during the stamping process.

The present application provides a battery including a battery cell and a shell. The shell includes a first cover body, a second cover body, and an annular middle frame. The annular middle frame is arranged between a first cover body and a second cover body; the first cover body, the annular middle frame, and the second cover body are sequentially connected to form a closed cavity, the battery cell is arranged in the closed cavity.

In the battery of an embodiment of the present application, the first cover body, the second cover body, and the annular middle frame can be independently processed and assembled to form the shell. Since the shell is formed by assembling the first cover body, the second cover body, and the annular middle frame, compared to the stamping process for integrally molding, independently processed first cover body, second cover body, and annular middle frame can solve problems of stacking, cracking, and other defects caused by plate deformation under force during the stamping process of an outer shell structure in the existing technology, which is conducive to improving the product yield of the shell.

According to an embodiment of the present application, a surface of the first cover body facing the closed cavity is provided with a first convex portion; a surface of the second cover body facing the closed cavity is provided with a second convex portion, and an inner wall of the annular middle frame abuts against the first convex portion and the second convex portion.

The first convex portion can be set as an annular shape with the same contour as the annular middle frame, so that the inner wall of the annular middle frame abuts against an outer edge of the first convex portion to achieve positioning of the first cover body and the annular middle frame. The second convex portion can be set as an annular shape with the same contour as the annular middle frame, so that the inner wall of the annular middle frame abuts against an outer edge of the second convex portion to achieve positioning of the second cover body and the annular middle frame.

According to an embodiment of the present application, the first cover body and the second cover body are respectively lapped to an upper end and a lower end of the annular middle frame.

Since the closed cavity needs to be filled with an electrolyte, batteries have high requirements for sealing. The lapping arrangement of the first cover body, the second cover body, and the annular middle frame can improve a sealing performance of the shell and prevent the electrolyte from leakage. Meanwhile, a way of lapping is simple in structure and has high stability.

According to an embodiment of the present application, the first cover body and the second cover body are each welded to the annular middle frame at a lapping position; a welded depth between the first cover body and the annular middle frame is greater than a thickness of the first cover body, and a welded depth between the second cover body and the annular middle frame is greater than a thickness of the second cover body.

The welded depth between the first cover body and the annular middle frame is greater than the thickness of the first cover body, so that the first cover body and the annular middle frame are sealingly connected at the lapping position. At the same time, the welded depth between the second cover body and the annular middle frame is greater than the thickness of the second cover body, so that the second cover body and the annular middle frame are sealingly connected at the lapping position. The first cover body, the second cover body and the annular middle frame after welding form the shell with a stable and reliable structure.

According to an embodiment of the present application, the battery cell includes a first tab and a second tab having an opposite polarity to the first tab; the battery further includes an electrode terminal. The electrode terminal is arranged on a side of the annular middle frame facing away from the closed cavity, the electrode terminal is set to be insulated from the annular middle frame, one of the first tab and the second tab passes through an opening provided in the annular middle frame to be electrically connected to the electrode terminal, and the other is electrically connected to one of the first cover body, the second cover body and the annular middle frame. Alternatively, the number of electrode terminals is two, the two electrode terminals are arranged on a side of the annular middle frame facing away from the closed cavity, where one electrode terminal is electrically connected to the first tab and the other electrode terminal is electrically connected to the second tab.

The electrode terminal is insulated from the annular middle frame. The first tab is electrically connected to the electrode terminal. The first tab is not electrically connected to the first cover body, the second cover body and the annular middle frame. The second tab can be electrically connected to any one of the first cover body, the second cover body, and the annular middle frame, and the connection positions are not limited and can be set according to an actual situation when forming a module.

According to an embodiment of the present application, a surface of the first cover body facing the closed cavity is perpendicular to the inner wall of the annular middle frame, and a surface of the second cover body facing the closed cavity is perpendicular to the inner wall of the annular middle frame.

The surface of the first cover body facing the closed cavity being perpendicular to the inner wall of the annular middle frame and the surface of the second cover body facing the closed cavity being perpendicular to the inner wall of the annular middle frame is conducive to increasing a volume of the closed cavity and facilitates setting a larger size of battery cell, thereby improving the energy density of the battery.

According to an embodiment of the present application, the annular middle frame is an integrally molded structure; alternatively, the annular middle frame includes two or more plates connected sequentially.

The annular middle frame with an integrally molded structure has high strength. Alternatively, the annular middle frame includes two or more plates connected sequentially. The plates can be connected by a welding process to improve the strength of the annular middle frame.

According to an embodiment of the present application, the annular middle frame is provided with a liquid injection hole and the battery is provided with a sealing component. The sealing component is connected to the annular middle frame to seal the liquid injection hole.

The annular middle frame is provided with the liquid injection hole, and the liquid injection hole is communicated with the closed cavity. After assembly of the first cover body, the second cover body, and the annular middle frame is completed, an electrolyte is injected into the closed cavity through the liquid injection hole. If the electrolyte leaks, battery performance will be affected. Meanwhile chemical components in the electrolyte are corrosive, and the leaked electrolyte will corrode the shell and affect the safety of the battery. Therefore, the sealing component is connected to the annular middle frame to seal the liquid injection hole. The sealing component is used to seal the liquid injection hole, thereby preventing leakage of the electrolyte from the liquid injection hole.

According to an embodiment of the present application, the sealing component includes a body and an insertion portion, the insertion portion is arranged on a surface of the body facing the closed cavity, the insertion portion is inserted into the liquid injection hole, and the body is connected to the annular middle frame to seal the liquid injection hole.

The sealing component includes the body and the insertion portion, the insertion portion is arranged on the surface of the body facing the closed cavity, and the insertion portion is inserted into the liquid injection hole, thereby achieving positioning of the sealing component, ensuring that the position of the body is at a predetermined position and connected to the annular middle frame to seal the liquid injection hole.

According to an embodiment of the present application, the body includes a first portion and a second portion, where a thickness of the first portion is less than that of the second portion, the insertion portion is arranged at the first portion, and a surface of the second portion facing the closed cavity is connected to the annular middle frame.

When a connection position between the first tab or the second tab and the annular middle frame is close to the liquid injection hole, the strength of the annular middle frame can be enhanced by the second portion with a larger thickness due to that the annular middle frame is a plate-shaped structure with a smaller thickness.

### BRIEF DESCRIPTION OF DRAWINGS

The drawings here are incorporated into the description and form a part of the present description, showing embodiments in accordance with the present application, and are used together with the description to explain the principles of the present application.

FIG. 1 is a structural schematic diagram of a battery according to an embodiment of the present application.

FIG. 2 is a schematic diagram of a breakdown structure of a battery according to an embodiment of the present application.

FIG. 3 is a structural sectional view taken along A-A direction in FIG. 1.

FIG. 4 is an enlarged schematic diagram at point I in FIG. 3.

FIG. 5 is a structural schematic diagram of a sealing component according to an embodiment of the present application.

FIG. 6 is a side view of a structure of a sealing component according to another embodiment of the present application.

Reference numbers:
1: Battery;
10. Shell;
10a. Closed cavity;
100. Welded mark;
11. First cover body;
111. First convex portion;
12. Second cover body;
121. Second convex portion;
13. Annular middle frame;
131. Opening;
132. Liquid injection hole;
20. Battery cell;
21. First tab;
22. Second tab;
30. Electrode terminal;
40. Sealing component;
41. Body;
411. First portion;
412. Second portion;
42. Insertion portion;
X. Axial direction.

Through the above drawings, specific embodiments of the present application have been shown, and more detailed descriptions will be provided in the following. These drawings and descriptions are not intended to limit the scope of the concept of the present application in any way, but rather to illustrate the concept of the present application for those skilled in the art with reference to specific embodiments.

### DESCRIPTION OF EMBODIMENTS

Here, a detailed explanation will be given to exemplary embodiments, which are shown in the drawings. When the following description relates to the drawings, the same reference numbers in different drawings represent the same or similar elements unless otherwise indicated. The embodiments described in the following exemplary embodiments do not represent all embodiments consistent with the present application. On the contrary, they are only examples of devices and methods consistent with some aspects of the present application as detailed in the claims.

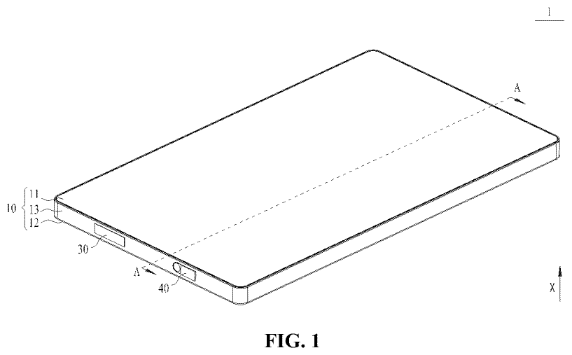

As shown in FIG. 1, a battery 1 of an embodiment of the present application includes a battery cell 20 and a shell 10. The shell 10 includes a first cover body 11, a second cover body 12, and an annular middle frame 13. The annular middle frame 13 is arranged between the first cover body 11 and the second cover body 12. The first cover body 11, the annular middle frame 13 and the second cover body 12 are sequentially connected to form a closed cavity 10a. The battery cell 20 is arranged in the closed cavity 10a. The closed cavity 10a is filled with an electrolyte. The first cover body 11, the second cover body 12 and the annular middle frame 13 are assembled to form the shell 10.

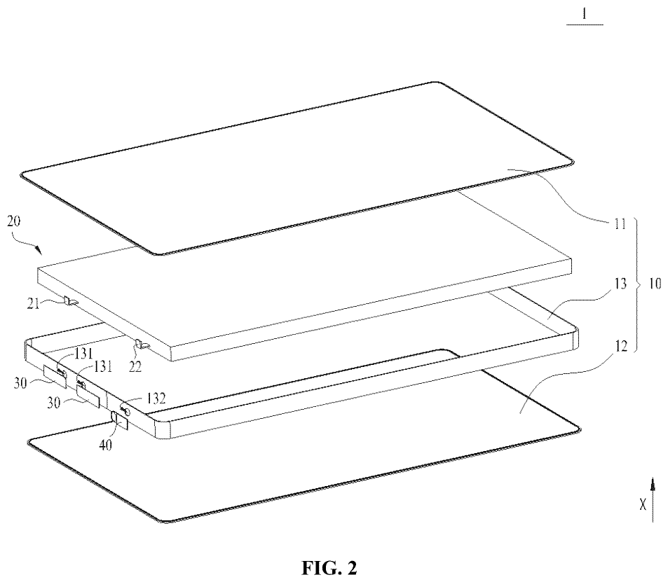

As shown in FIG. 2, the shell 10 is a split assembly structure. The first cover body 11, the second cover body 12 and the annular middle frame 13 can be independently processed and assembled to form the shell 10. Due to the fact that the shell 10 is formed by sequentially assembling the first cover body 11, the annular middle frame 13 and the second cover body 12, the independently processed first cover body 11, second cover body 12 and annular middle frame 13 can solve problems of stacking, cracking and other defects caused by deformation of plates under force during a stamping process of an outer shell structure in the existing technology, compared to a stamping process for integrally molding.

In the embodiment of the present application, the battery 1 can be a lithium-ion battery. The battery 1 can be a square structure. The square battery 1 has a simple structure, which can avoid space waste when forming a battery module and is beneficial to improving the energy density of the battery module.

The first cover body 11, the second cover body 12 and the annular middle frame 13 can be a metal material, which can render the shell 10 having a high strength and effectively prevent the shell 10 of the battery 1 from being punctured during transportation, leading to electrolyte leakage. The first cover body 11 and the second cover body 12 can have a plate-shaped structure. The plate-shaped structure is easy to be processed and manufactured. In addition, the first cover body 11 and the second cover body 12 can have identical structure to reduce the number of parts and maintenance costs. At the same time, the identical structure can avoid incorrect installation of the first cover body 11 and the second cover body 12 in an assembly process of the shell 10, resulting in a repeated installation of the shell 10 and reducing assembly efficiency.

The first cover body 11 and the second cover body 12 can each have a thickness range of 0.05 mm to 0.3 mm. The annular middle frame 13 is an internally hollow annular structure. The annular middle frame 13 can have a wall thickness range of 0.1 mm to 0.3 mm. The annular middle frame 13 is arranged between the first cover body 11 and the second cover body 12. The wall thickness of the annular middle frame 13 is greater than or equal to a thickness of the first cover body 11, and the wall thickness of the annular middle frame 13 is greater than or equal to the thickness of the second cover body 12. The first cover body 11, the second cover body 12 and the annular middle frame 13 in a plate-shaped structure can help to reduce a weight of the battery 1.

The first cover body 11, the second cover body 12 and the annular middle frame 13 each have a simple structure, so that they can be processed using a mold. Moreover, the manufacturing process of the mold is simple and can achieve high processing accuracy.

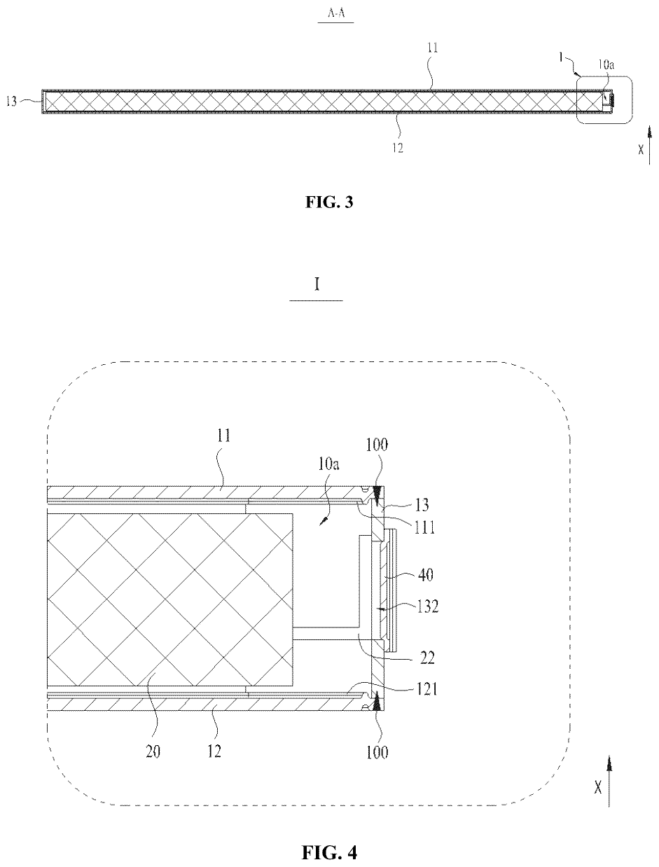

In some implementation modes, as shown in FIGS. 3 and 4, a surface of the first cover body 11 facing the closed cavity 10a is provided with a first convex portion 111, and a surface of the second cover body 12 facing the closed cavity 10a is provided with a second convex portion 121. An inner wall of the annular middle frame 13 abuts against the first convex portion 111 and the second convex portion 121. The first convex portion 111 can be arranged in an annular shape similar to a contour of the annular middle frame 13, so that the inner wall of the annular middle frame 13 abuts against an outer edge of the first convex portion 111, in order to achieve positioning of the first cover body 11 and the annular middle frame 13. The second convex portion 121 can be arranged in an annular shape similar to the contour of the annular middle frame 13, so that the inner wall of the annular middle frame 13 abuts against an outer edge of the second convex portion 121, so as to achieve positioning of the second cover body 12 and the annular middle frame 13. Exemplarily, the first convex portion 111 and the second convex portion 121 are processed using a stamping process.

Height and width dimensions of the first convex portion 111 and the second convex portion 121 should occupy as little space as possible in the closed cavity 10a whiling meeting the positioning requirement, so that a large size of battery cell 20 can be provided in the closed cavity 10a, which is beneficial to improving the energy density of the battery 1. In some examples, the first convex portion 111 has a raised height less than or equal to the thickness of the first cover body 11. Exemplarily, the width of the first convex portion 111 is less than or equal to 0.25 mm. The second convex portion 121 has a raised height less than or equal to the thickness of the second cover body 12. Exemplarily, the width of the second convex portion 121 is less than or equal to 0.25 mm.

As shown in FIG. 3, the first cover body 11 and the second cover body 12 of an embodiment of the present application are respectively lapped to an upper end and a lower end of the annular middle frame 13. Due to that the closed cavity 10a needs to be filled with an electrolyte, the battery 1 has a high requirement for sealing. A lapping arrangement of the first cover body 11, the second cover body 12 and the annular middle frame 13 can improve the sealing performance of the shell 10 and prevent the electrolyte from leakage. Meanwhile, the way of lapping is simple in structure and has high stability.

Exemplarily, the first cover body 11, the annular middle frame 13 and the second cover body 12 are sequentially arranged along an axial direction X of the annular middle frame 13. Along the axis direction X, the annular middle frame 13 has two end surfaces, i.e., the upper end surface and the lower end surface. The first cover body 11 and the second cover body 12 are respectively lapped to the upper end surface and lower end surface of the annular middle frame 13. An outer edge of the first cover body 11 is lapped to one end surface of the annular middle frame 13, while an outer edge of the second cover body 12 is lapped to the other end surface of the annular middle frame 13. The outer edge of the first cover body 11 and the outer edge of the second cover body 12 can be flush with an outer wall of the annular middle frame 13 to avoid reducing an energy density of a battery module due to space waste caused by the first cover body 11 or the second cover body 12 exceeding the annular middle frame 13 when forming the battery module.

In some implementation mode, as shown in FIG. 4, the first cover body 11 and the second cover body 12 of an embodiment of the present application are each welded to the annular middle frame 13 at a lapping position. Exemplarily, during a welding process of the first cover body 11 to the annular middle frame 13, the first cover body 11 and the annular middle frame 13 are arranged sequentially along the axial direction X of the annular middle frame 13. A welding gun acts on a surface of the first cover body 11 facing away from the closed cavity 10a, thereby forming a welded mark 100 at the lapping position between the first cover body 11 and the annular middle frame 13. The welded mark 100 extends along the axis direction X. The welded mark 100 runs through the first cover body 11 and extends to an interior of the annular middle frame 13.

Exemplarily, a welded depth between the first cover body 11 and the annular middle frame 13 is greater than the thickness of the first cover body 11, so that the first cover body 11 and the annular middle frame 13 are sealingly connected at the lapping position. After the first cover body 11 and the annular middle frame 13 are welded as a whole, the welding gun acts on a surface of the second cover body 12 facing away from the closed cavity 10a, thereby forming a welded mark 100 at the lapping position between the second cover body 12 and the annular middle frame 13. The welded mark 100 extends along the axis direction X. The welded mark 100 runs through the second cover body 12 and extends to the interior of the annular middle frame 13. Exemplarily, at the same time, a welded depth between the second cover body 12 and the annular middle frame 13 is greater than the thickness of the second cover body 12, so that the second cover body 12 and the annular middle frame 13 are sealingly connected at the lapping position. The first cover body 11, the second cover body 12 and the annular middle frame 13 after welding form the shell 10 with a stable and reliable structure.

In some implementation mode, as shown in FIG. 2, the battery cell 20 of an embodiment of the present application includes a first tab 21 and a second tab 22 with an opposite polarity to the first tab 21. The battery 1 further includes an electrode terminal 30. The electrode terminal 30 is used to connect the first tab 21 or the second tab 22. The electrode terminal 30 is arranged on a side of the annular middle frame 13 facing away from the closed cavity 10a to facilitate an electrical connection between the electrode terminals 30 of adjacent two batteries 1 when forming a battery module. The electrode terminal 30 is set to be insulated from the annular middle frame 13. An insulation pad can be provided between the electrode terminal 30 and the annular middle frame 13.

In some examples, the annular middle frame 13 is provided with an opening 131. The first tab 21 passes through the opening 131 arranged in the annular middle frame 13 to be electrically connected to the electrode terminal 30. Exemplarily, the opening 131 is a through hole. The first tab 21 is not electrically connected to the first cover body 11, the second cover body 12 and the annular middle frame 13. The second tab 22 can be electrically connected to any one of the first cover body 11, the second cover body 12 and the annular middle frame 13, and their connection positions may not be limited and can be set according to an actual situation when forming the battery module.

In other examples, there are two electrode terminals 30. The two electrode terminals 30 are all located on a side of the annular middle frame 13 facing away from the closed cavity 10a. One electrode terminal 30 is electrically connected to the first tab 21, and the other electrode terminal 30 is electrically connected to the second tab 22. At this time, both the first tab 21 and the second tab 22 are insulated and connected to the shell 10.

In some examples, as shown in FIGS. 3 and 4, in an embodiment of the present application, a surface the first cover body 11 facing the closed cavity 10a is perpendicular to an inner wall of the annular middle frame 13, and a surface of the second cover body 12 facing the closed cavity 10a is perpendicular to the inner wall of the annular middle frame 13. The battery cell 20 can be formed using a lamination process. The lamination process involves stacking a positive electrode sheet, an insulation diaphragm, and a negative electrode sheet to form the battery cell 20. Cross-sections of the battery cell 20 in both horizontal and vertical directions can be rectangular. The surface of the first cover body 11 facing the closed cavity 10a being perpendicular to the inner wall of the annular middle frame 13 and the surface of the second cover body 12 facing the closed cavity 10a being perpendicular to the inner wall of the annular middle frame 13 can help to increase a volume of the closed cavity 10a and facilitate to set a larger size of battery cell 20, thereby improving the energy density of the battery 1.

In some implementation mode, the annular middle frame 13 of an embodiment of the present application is an integrally molded structure. The annular middle frame 13 with an integrally molded structure has high strength. Alternatively, the annular middle frame 13 includes two or more plates connected sequentially. For example, the annular middle frame 13 includes sequentially connected four plates and thus the annular middle frame 13 is in a rectangular shape. A connection mode between the plates can be adopting a welding process to improve the strength of the annular middle frame 13.

As shown in FIG. 4, the annular middle frame 13 of an embodiment of the present application is provided with a liquid injection hole 132. The liquid injection hole 132 is communicated with the closed cavity 10a. After assembly of the first cover body 11, the second cover body 12 and the annular middle frame 13 is completed, an electrolyte is injected into the closed cavity 10a through the liquid injection hole 132.

The battery 1 is provided with a sealing component 40. The battery 1 is internally filled with the electrolyte. If the electrolyte leaks, the performance of battery 1 will be affected. Meanwhile since chemical components in the electrolyte are corrosive, the leaked electrolyte will corrode the shell 10 and affect the safety of the battery 1. Therefore, the sealing component 40 is connected to the annular middle frame 13 to seal the liquid injection hole 132. The sealing component 40 is used to seal the liquid injection hole 132, thereby preventing leakage of the electrolyte from the liquid injection hole 132. A sealing mode can be welding the sealing component 40 to the annular middle frame 13. A welding mode can be laser welding.

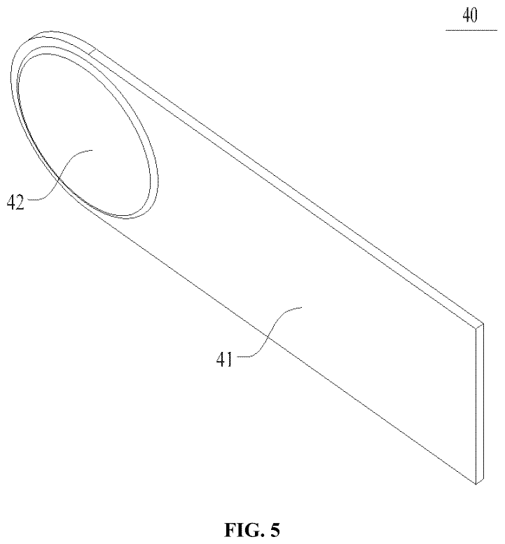

As shown in FIG. 5, the sealing component 40 of an embodiment of the present application includes a body 41 and an insertion portion 42. The insertion portion 42 is arranged on a surface of the body 41 facing the closed cavity 10a. The insertion portion 42 is inserted into the liquid injection hole 132 to achieve positioning of the sealing component 40 for sealing. The body 41 is connected to the annular middle frame 13 to seal the liquid injection hole 132. The electrolyte is corrosive and thus the sealing component 40 needs to have corrosion resistance. Exemplarily, the sealing component 40 can be of stainless-steel material. After sealing between the sealing component 40 and the liquid injection hole 132 is implemented, it is necessary to conduct a helium test to check the overall sealing of the battery 1, so as to avoid a problem of electrolyte leakage caused by poor sealing of an assembled battery 1.

In some implementation modes, as shown in FIG. 5, the body 41 of an embodiment of the present application has a uniform thickness. The body 41 can have a strip plate shaped structure.

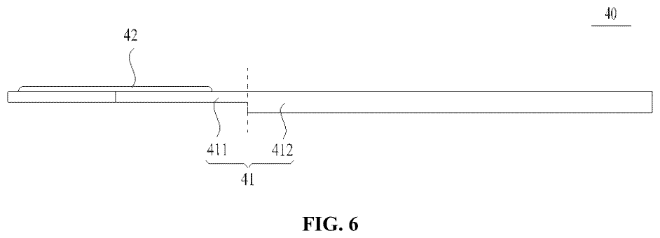

In other implementable modes, as shown in FIG. 6, the body 41 includes a first portion 411 and a second portion 412. A thickness of the first portion 411 is smaller than that of the second portion 412. The insertion portion 42 is arranged in the first portion 411. A surface of the second portion 412 facing the closed cavity 10a is connected to the annular middle frame 13. When a connection position between the first tab 21 or the second tab 22 and the annular middle frame 13 is close to the liquid injection hole 132, the strength of the annular middle frame 13 can be enhanced through the second portion 412 with a larger thickness since the annular middle frame 13 is a plate-shaped structure with a smaller thickness. The connection position between the first tab 21 or the second tab 22 and the annular middle frame 13 is set in an area corresponding to the second portion 412.

Exemplarily, the first portion 411 can have a shape same as the insertion portion 42, and in an axial direction of the insertion portion 42, an orthographic projection of the insertion portion 42 in the axial direction of the insertion portion 42 is located within an orthographic projection of the first portion 411 in its axial direction, so that after the insertion portion 42 is inserted into the liquid injection hole 132, a contact area between the first portion 411 and the annular middle frame 13 is greater than a contact area between the first portion 411 and the liquid injection hole 132, thereby improving the sealing effect of the sealing component 40.

In the description of the embodiments of the present application, it should be noted that terms “installation”, “connection to”, and “connection with” should be understood broadly unless otherwise specified and limited. For example, they can be a fixed connection, or an indirect connection through an intermediate media, or it can be an internal communication between two components, or an interaction relationship between two components. For ordinary technical person in the art, specific meanings of the above terms in the embodiments of the present application can be understood based on specific circumstances.

The embodiments of the present application do not imply that the mentioned devices or components must have a specific orientation, or be constructed and operated in a specific orientation, and thus cannot be understood as a limitation on the present application. In the description of the embodiments of the present application, the meaning of “multiple” refers to two or more, unless otherwise precisely and specifically specified.

Terms “first”, “second”, “third”, “fourth” and the like (if any) in the description of the embodiments of the present application and claims as well as the drawings are used to distinguish similar objects without necessarily describing a specific order or sequence. It should be understood that the data used in this way can be interchanged where appropriate, so that the embodiments described here can be implemented in an order other than those shown in the drawings or described here, for example.

In addition, terms “including” and “having” as well as any variations thereof, are intended to cover non-exclusive inclusion. For example, a process, method, system, product or device, which includes a series of steps or units, need not be limited to those clearly listed steps or units, but may include other steps or units that are not clearly listed or inherent to the process, method, product, or device.

The term “multiple” in the description refers to two or more. The term “and/or” in the present description is only a description of the association relationship between related objects, indicating that there can be three types of relationships. For example, A and/or B can represent three situations: presence of A alone, presence of both A and B, and presence of B alone. In addition, character “/” in the present description generally represents that the associated objects before and after it are in an “or” relationship; in the formula, the character “/” represents that the associated objects before and after it are in a “divide by” relationship.

It can be understood that the various reference numbers involved in the embodiments of the present application are only for distinction for convenience of description, and are not intended to limit the scope of the embodiments of the present application.

It can be understood that in the embodiments of the present application, the value of the sequence numbers of the above-mentioned processes does not mean the order of execution. The execution order of the processes should be determined based on their functions and internal logics, and should not constitute any restriction on the implementation process of the embodiments of the present application.

What is claimed is:

1. A battery, comprising:
a battery cell;
a shell comprising a first cover body, a second cover body and an annular middle frame, wherein the annular middle frame is arranged between the first cover body and the second cover body, the first cover body, the annular middle frame and the second cover body are sequentially connected to form a closed cavity, the battery cell is arranged in the closed cavity.

2. The battery according to claim 1, wherein a surface of the first cover body facing the closed cavity is provided with a first convex portion, a surface of the second cover body facing the closed cavity is provided with a second convex portion, and an inner wall of the annular middle frame abuts against the first convex portion and the second convex portion.

3. The battery according to claim 1, wherein the first cover body and the second cover body are respectively lapped to an upper end and a lower end of the annular middle frame.

4. The battery according to claim 3, wherein the first cover body and the second cover body are each welded to the annular middle frame at a lapping position; a welded depth between the first cover body and the annular middle frame is greater than a thickness of the first cover body, and a welded depth between the second cover body and the annular middle frame is greater than a thickness of the second cover body.

5. The battery according to claim 1, wherein the battery cell comprises a first tab and a second tab with an opposite polarity to the first tab; the battery further comprises an electrode terminal, the electrode terminal is arranged on a side of the annular middle frame facing away from the closed cavity, and the electrode terminal is set to be insulated from the annular middle frame; one of the first tab and the second tab passes through an opening provided in the annular middle frame to be electrically connected to the electrode terminal, and the other is electrically connected to one of the first cover body, the second cover body and the annular middle frame; or
there are two electrode terminals, the two electrode terminals are arranged on the side of the annular middle frame facing away from the closed cavity; one electrode terminal is electrically connected to the first tab, and the other electrode terminal is electrically connected to the second tab.

6. The battery according to claim 2, wherein the battery cell comprises a first tab and a second tab with an opposite polarity to the first tab; the battery further comprises an electrode terminal, the electrode terminal is arranged on a side of the annular middle frame facing away from the closed cavity, and the electrode terminal is set to be insulated from the annular middle frame; one of the first tab and the second tab passes through an opening provided in the annular middle frame to be electrically connected to the electrode terminal, and the other is electrically connected to one of the first cover body, the second cover body and the annular middle frame; or
there are two electrode terminals, the two electrode terminals are arranged on the side of the annular middle frame facing away from the closed cavity; one electrode terminal is electrically connected to the first tab, and the other electrode terminal is electrically connected to the second tab.

7. The battery according to claim 3, wherein the battery cell comprises a first tab and a second tab with an opposite polarity to the first tab; the battery further comprises an electrode terminal, the electrode terminal is arranged on a side of the annular middle frame facing away from the closed cavity, and the electrode terminal is set to be insulated from the annular middle frame; one of the first tab and the second tab passes through an opening provided in the annular middle frame to be electrically connected to the electrode terminal, and the other is electrically connected to one of the first cover body, the second cover body and the annular middle frame; or
there are two electrode terminals, the two electrode terminals are arranged on the side of the annular middle frame facing away from the closed cavity; one electrode terminal is electrically connected to the first tab, and the other electrode terminal is electrically connected to the second tab.

8. The battery according to claim 4, wherein the battery cell comprises a first tab and a second tab with an opposite polarity to the first tab; the battery further comprises an electrode terminal, the electrode terminal is arranged on a side of the annular middle frame facing away from the closed cavity, and the electrode terminal is set to be insulated from the annular middle frame; one of the first tab and the second tab passes through an opening provided in the annular middle frame to be electrically connected to the electrode terminal, and the other is electrically connected to one of the first cover body, the second cover body and the annular middle frame; or
there are two electrode terminals, the two electrode terminals are arranged on the side of the annular middle frame facing away from the closed cavity; one electrode terminal is electrically connected to the first tab, and the other electrode terminal is electrically connected to the second tab.

9. The battery according to claim 1, wherein a surface of the first cover body facing the closed cavity is perpendicular to an inner wall of the annular middle frame, and a surface of the second cover body facing the closed cavity is perpendicular to the inner wall of the annular middle frame.

10. The battery according to claim 2, wherein the surface of the first cover body facing the closed cavity is perpendicular to the inner wall of the annular middle frame, and the surface of the second cover body facing the closed cavity is perpendicular to the inner wall of the annular middle frame.

11. The battery according to claim 3, wherein a surface of the first cover body facing the closed cavity is perpendicular to the inner wall of the annular middle frame, and the surface of the second cover body facing the closed cavity is perpendicular to the inner wall of the annular middle frame.

12. The battery according to claim 4, wherein a surface of the first cover body facing the closed cavity is perpendicular to the inner wall of the annular middle frame, and the surface of the second cover body facing the closed cavity is perpendicular to the inner wall of the annular middle frame.

13. The battery according to claim 1, wherein the annular middle frame is an integrally molded structure; or the annular middle frame comprises two or more plates connected sequentially.

14. The battery according to claim 2, wherein the annular middle frame is an integrally molded structure; or the annular middle frame comprises two or more plates connected sequentially.

15. The battery according to claim 3, wherein the annular middle frame is an integrally molded structure; or the annular middle frame comprises two or more plates connected sequentially.

16. The battery according to claim 4, wherein the annular middle frame is an integrally molded structure; or the annular middle frame comprises two or more plates connected sequentially.

17. The battery according to claim 1, wherein the annular middle frame is provided with a liquid injection hole, the battery is provided with a sealing component, which is connected to the annular middle frame to seal the liquid injection hole.

18. The battery according to claim 2, wherein the annular middle frame is provided with a liquid injection hole, the battery is provided with a sealing component, which is connected to the annular middle frame to seal the liquid injection hole.

19. The battery according to claim 18, wherein the sealing component comprises a body and an insertion portion, wherein the insertion portion is arranged on a surface of the body facing the closed cavity, the insertion portion is inserted into the liquid injection hole, and the body is connected to the annular middle frame to seal the liquid injection hole.

20. The battery according to claim 19, wherein the body comprises a first portion and a second portion, wherein the first portion has a thickness less than the second portion, and the insertion portion is arranged on the first portion, wherein a surface of the second portion facing the closed cavity is connected to the annular middle frame.
